(19) United States
(12) Patent Application Publication
(10) Pub. No.: US 2026/0032219 A1
(43) Pub. Date: Jan. 29, 2026

(54) SATELLITE DEPLOYED SYSTEM FOR ONBOARD ARTIFICIAL INTELLIGENCE ANALYSIS OF HYPERSPECTRAL DATA CUBES AND RELATED METHODS

(71) Applicant: ACME ATRONOMATIC, LLC, Orlando, FL (US)

(72) Inventor: SARVESH GARIMELLA, Portland, OR (US)

(21) Appl. No.: 19/284,105

(22) Filed: Jul. 29, 2025

Related U.S. Application Data
(60) Provisional application No. 63/676,612, filed on Jul. 29, 2024.

(51) Int. Cl. H04N 7/18; G06V 10/82; G06V 20/10; G06V 20/13; H04B 7/185

(52) U.S. Cl. CPC H04N 7/183; G06V 10/82; G06V 20/13; G06V 20/194; H04B 7/18586

(57) ABSTRACT

A satellite sensing payload may include a plurality of hyperspectral imaging sensors configured to capture sensor data across a plurality of wavelengths, and a communication device configured to communicate with a ground station. The satellite sensing payload may also include an artificial intelligence (AI) processing and analysis unit configured to store the captured sensor data in data cubes, process the data cubes to generate at least one sensor insight based thereon, and communicate the at least one sensor insight with the ground station via the communication device.

### TECHNICAL FIELD

The present invention relates to satellite technology and advanced data analytics, and, more particularly, to a satellite deployed system for onboard artificial intelligence (AI) analysis of hyperspectral data cubes and related methods.

### BACKGROUND

Satellites equipped with hyperspectral sensors play a critical role in monitoring environmental conditions, detecting natural disasters, managing agricultural resources, and supporting defense and intelligence operations. Hyperspectral imaging captures data across hundreds of contiguous spectral bands, producing large volumes of high-dimensional data, commonly referred to as hyperspectral data cubes. The analysis of such data provides rich and precise information that is not attainable with traditional broadband or multispectral imaging.

Despite the capabilities of hyperspectral imaging, the utility of this data is often limited by constraints in data transmission bandwidth between the satellite and ground stations. In conventional systems, the satellite captures hyperspectral data and transmits the full-resolution raw or minimally processed data cubes to ground stations. This downlink-centric architecture often requires the transmission of several gigabytes of data per observation, far exceeding the available bandwidth for many small satellite platforms, particularly those operating in low Earth orbit (LEO) with short ground contact windows.

As a result, valuable information remains locked onboard the satellite until transmission is completed, introducing latency that hinders real-time decision making and responsiveness. This is a particular problem in time-critical applications such as wildfire detection, oil spill monitoring, or emergency response. Additionally, the inability to selectively analyze and prioritize data onboard results in inefficient use of satellite and ground resources.

Current solutions are limited to predefined event detection or basic compression and lack the flexibility of real-time, user-driven analysis. Moreover, there is no implementation to facilitate dynamic querying and interpretive interaction by end users, particularly for complex or evolving Earth observation scenarios.

Accordingly, there remains a need in the art for improved systems and methods that address the challenges associated with the handling of large volumes of hyperspectral imaging data generated by satellites. In particular, there is a need for solutions that overcome the limitations of restricted communication bandwidth and enable more timely, efficient, and actionable use of hyperspectral data collected in orbit. Additionally, there is a need for techniques that facilitate enhanced utilization of onboard sensor data, including the ability to support more responsive and interactive communication between spaceborne platforms and ground-based users. These improvements are particularly important in time sensitive or bandwidth constrained operational environments.

### SUMMARY

A satellite sensing payload may include a plurality of hyperspectral imaging sensors configured to capture sensor data across a plurality of wavelengths, and a communication device configured to communicate with a ground station. The satellite sensing payload may also include an artificial intelligence (AI) processing and analysis unit configured to store the captured sensor data in data cubes, process the data cubes to generate at least one sensor insight based thereon, and communicate the at least one sensor insight with the ground station via the communication device.

The AI processing and analysis unit may also be configured to communicate the at least one sensor insight in real-time. In addition, the AI processing and analysis unit may be configured to engage in dialogue via the communication device and the ground station.

The communication of the at least one insight may require less bandwidth than would otherwise be required by communication of the captured sensor data.

The AI processing and analysis unit may be configured to operate a Large Language Model (LLM), such as to identify at least one of a pattern, anomaly, and trend to generate the at least one sensor insight. The AI processing and analysis unit may also be configured to receive a user query from the ground station and dynamically generate a responsive sensor insight based on the stored data cubes. The AI processing and analysis unit may be configured to assign a priority value to each sensor insight based on a relevance score or event threshold and to selectively transmit insights exceeding a predetermined priority level.

In a particular aspect, the sensor insight may comprise a textual summary, a geolocation tag, or a structured data packet formatted for human or machine interpretation.

A method aspect is directed to satellite sensing and may comprise operating a plurality of hyperspectral imaging sensors of a satellite sensing payload to capture sensor data across a plurality of wavelengths. The method may also include operating an artificial intelligence (AI) processing and analysis unit of the satellite sensing payload unit to store the captured sensor data in data cubes, process the data cubes to generate at least one sensor insight based thereon, and communicate the at least one sensor insight with a ground station via a communication device of the satellite sensing payload.

Operating the AI processing and analysis unit may include operating the AI processing and analysis unit to communicate the at least one sensor insight in real-time. The AI processing and analysis unit may also be operated to engage in dialogue via the communication device and the ground station.

The communication of the at least one sensor insight may require less bandwidth than would otherwise be required by communication of the captured sensor data.

The AI processing and analysis unit may operate a Large Language Model (LLM). For example, the LLM may be used to identify at least one of a pattern, anomaly, and trend to generate the at least one sensor insight.

### BRIEF DESCRIPTION OF THE DRAWINGS

FIG. 1 is a schematic illustrating a system having hyperspectral sensors, an onboard AI processing unit for processing data and generating alerts, and a communication module in accordance with a particular embodiment of the invention;

FIG. 2 is a schematic diagram illustrating the method for autonomous detection, onboard data processing and analysis, alerting, and interactive communication of insights in accordance with a particular embodiment of the invention; and

FIG. 3 is a concept of operations (CONOPS) diagram depicting real-time alerting and interactive communication for hazard alerting use cases for wildfires and oil spills using the system and method of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The invention is directed to a transformative approach in satellite hyperspectral imaging and analysis, leveraging onboard artificial intelligence (AI) to enhance data utility and communication efficiency in Earth observation and monitoring tasks. In particular, the invention includes an innovative method and system for onboard processing of hyperspectral data cubes using AI, which enables real-time alerting and facilitates low bandwidth interactive communication with an onboard AI large language model analyst.

The system, generally designated, is designed to interactively analyze hyperspectral data onboard a satellite 102, extract significant insights, and communicate these insights to ground stations without needing to transmit the entire raw dataset, thus circumventing the bandwidth bottleneck issue. It further allows for the end user of the data to engage in two-way interactive communication with the satellite to gain additional insights from the data not contained in the original alert.

An advantage of the system includes optimizing bandwidth usage by processing data onboard and transmitting only essential insights. Another advantage of the system 100 is that it enables timely and informed decision-making through real-time AI analysis and interactive communication. In addition, the system enhances the capability of satellite systems to monitor and respond to dynamic phenomena effectively.

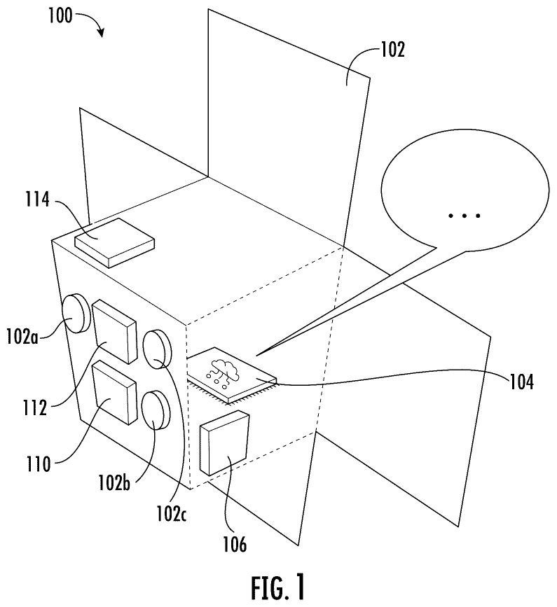

Referring now to FIG. 1, the system 100 comprises a compact satellite 102 outfitted with a satellite sensing payload comprising advanced hyperspectral imaging sensors 102a, 102b, 102c capable of capturing data across an extensive range of wavelengths with high spatial and spectral resolution. The system 100 incorporates a robust onboard AI processing unit 104, designed specifically for the analysis of large hyperspectral data cubes. The AI processing unit 104 hosts a sophisticated large language model (LLM) capable of conducting detailed data analysis, generating insights, and supporting interactive dialogues. Using a LLM onboard to generate human-readable insights, and respond in natural language to queries is not taught or suggested in any known reference. LLMs are computationally intensive, and running them onboard spacecraft represents a paradigm shift in how satellite data is used.

As used herein, the term insights or “sensor insight” refers to an interpreted, derived, or summarized analytical result generated by processing the raw hyperspectral sensor data using the onboard AI processing unit 104. A sensor insight may include, but is not limited to, identification of anomalies, classification of surface materials, detection of trends or changes over time, identification of environmental hazards (e.g., fires, oil spills, or deforestation), estimation of chemical or biological signatures, or generation of summary statistics or decision-support indicators.

Sensor insights differ from raw or preprocessed sensor data in that they represent higher-level conclusions or semantic interpretations of the sensed environment, typically formatted for human consumption or downstream automated decision-making. In particular, the onboard AI processing unit 104 uses the LLM to extract such insights from the data cubes in near-real time. These insights may be presented in the form of textual summaries, alert messages, heatmaps, confidence scores, a geolocation tag, structured data packet, or other structured data packet formatted for human or machine interpretation.

The generation of sensor insights onboard allows the system 100 to transmit the most relevant or actionable information to the ground station, thereby optimizing bandwidth utilization and enabling more timely response to sensed events. It also enables interactive querying, where the ground operator may request additional insights, clarifications, or contextual explanations, which are then dynamically generated by the onboard AI in response to such user input. The AI processing and analysis unit 104 may be configured to assign a priority value to each sensor insight based on a relevance score or event threshold and to selectively transmit insights exceeding a predetermined priority level.

The satellite's communication module 106, utilizing, e.g., radio or optical links depending on the particular embodiment, is optimized for low bandwidth transmissions to enable efficient downlink of processed information and facilitating real-time communication with ground-based operators. Existing systems collect hyperspectral data onboard, downlink it to the ground, and perform analysis post-download. They may allow alerts or simple status messages (e.g., “fire detected”) but none of the existing systems allow an operator to interact conversationally with an onboard AI to request custom analysis, ask follow-up questions, or explore the data context, for example. The approach of the present invention redefines satellite interaction from “data push” to “interactive dialogue” similar to having an onboard analyst.

The bandwidth requirements are significantly reduced for data transmission by performing onboard analysis of hyperspectral data and transmitting only the resulting sensor insights, rather than the full-resolution raw or minimally processed data cubes. Hyperspectral data cubes are inherently large due to their high spatial and spectral resolution, often comprising hundreds of spectral bands per pixel across wide swaths of terrain. Conventional systems transmit these large datasets to ground stations for post-processing, requiring substantial downlink bandwidth and often creating delays in data utilization.

In contrast, the present invention employs an onboard AI processing and analysis unit 104 that extracts key information—such as environmental anomalies, material classifications, or actionable events—from the data cubes in real-time. These sensor insights, which may be orders of magnitude smaller in size than the original datasets, can be formatted as compact structured data (e.g., alerts, summaries, geotagged event lists) suitable for low-bandwidth transmission.

For example, a single hyperspectral data cube covering 30 km×30 km at 30-meter resolution with 200 spectral bands may result in a data volume exceeding 1 gigabyte per scene. In contrast, an onboard-generated sensor insight summarizing an event of interest (e.g., a wildfire alert with geolocation, confidence score, and explanation) can be transmitted in less than 10 kilobytes, representing a reduction of over 99.9% in transmission volume.

By shifting the analytical burden from ground-based infrastructure to the satellite itself, the system 100 minimizes the need for continuous high-volume data downlink. This approach not only improves communication efficiency but also extends mission viability for satellites operating with limited bandwidth, intermittent ground contact, or in contested or denied environments. The bandwidth-efficient transmission of sensor insights also facilitates faster situational awareness and decision-making, which is critical for time-sensitive applications such as disaster response, defense monitoring, or agricultural forecasting.

The satellite 102 is equipped with distinct communication modules operating in the X-band, S-band, and L-band frequency ranges, each selected and integrated to optimize signal performance, data throughput, and mission flexibility. For example, the system 100 includes an X-band downlink module 110 configured to transmit payload data from the satellite to one or more ground stations. The X-band module 110 operates in the frequency range of approximately 7.9 to 8.4 GHZ and includes a high-power transmitter (e.g., solid-state power amplifier or traveling-wave tube amplifier), a digital modulator capable of applying modulation schemes such as QPSK or 8PSK, and a high-gain directional antenna. This configuration enables high-rate transmission of data such as hyperspectral data cubes. The antenna may be mechanically or electronically steerable to target ground-based receiving stations and is optimized for minimal signal loss and beam divergence in low Earth orbit (LEO) or medium Earth orbit (MEO) deployments.

The system 100 also includes an S-band uplink module 112 configured to receive commands and telemetry requests from a ground station. The S-band module 112 operates in the frequency range of approximately 2.0 to 2.3 GHZ and comprises a low-noise receiver, a demodulator, and an omnidirectional or hemispherical antenna. The S-band module 112 supports low-data-rate but critical communications required for satellite control, software updates, and telemetry interrogation.

In addition, to support networked operation of multiple satellites, the system 100 includes an L-band inter-satellite link (ISL) module 114. The L-band module 114 operates in the frequency range of approximately 1.0 to 2.0 GHZ, more particularly near 1.6 GHZ, and includes a transceiver capable of bidirectional communication. The ISL module 114 may employ medium-gain antenna arrays or electronically steerable patch antennas to exchange data packets between adjacent satellites in a constellation. These data packets may include orbital coordination messages, tasking updates, crosslink telemetry, and payload data relays.

Each of the communication modules is operably coupled to the communications module 106 that governs data prioritization, routing, and buffering. A shared frequency duplexer, switch matrix, or software-defined radio platform may coordinate RF signal flow and band isolation, allowing seamless operation across the X, S, and L bands.

By integrating X-band for high-throughput downlink, S-band for robust command uplink, and L-band for flexible inter-satellite communication, the system 100 provides a comprehensive communications backbone that reduces ground station dependency, enables real-time constellation coordination, and supports scalable data distribution architectures. This modular, multi-band design enhances the operational autonomy and mission agility of the satellite or satellite network.

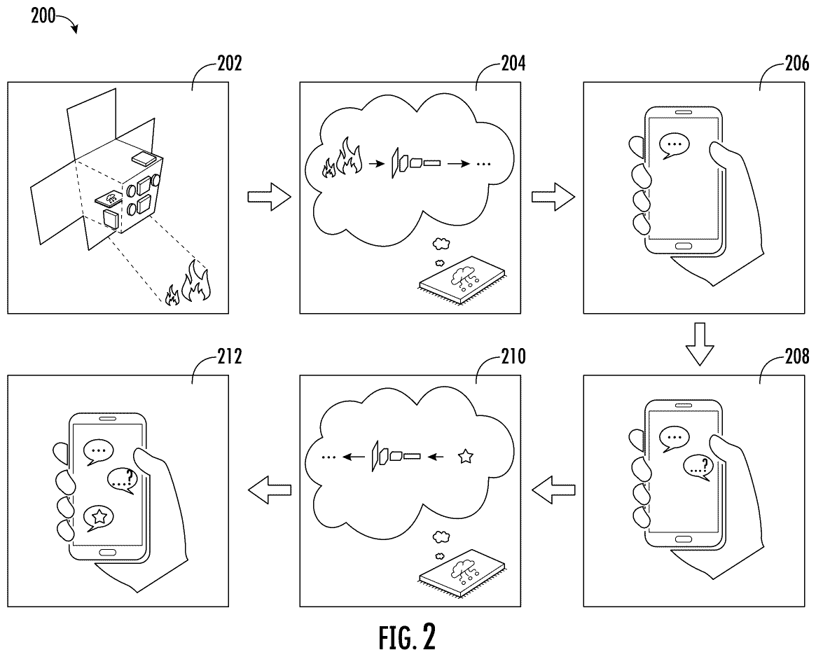

Referring now to FIG. 2, a method sequence 200 for autonomous detection, onboard data processing and analysis, alerting, and interactive communication of insights is depicted. The method includes capturing data across a plurality of wavelengths from a plurality of hyperspectral imaging sensors, at Block 202. The data is stored in data cubes, where the data includes high spatial and spectral resolution information. The method includes, at 204, onboard AI algorithms preprocessing the hyperspectral data to reduce noise and extract relevant features and compressing the information without losing critical details. The method also includes an AI large language model (LLM) analyzing these preprocessed data, identifying patterns, anomalies, and trends, and synthesizing actionable insights. The method includes, at Block 206, transmitting the insights from the hyperspectral data analytics to a ground-based operator using a low bandwidth communication system. In addition, the method includes ground operators interacting with the onboard AI through a secure communication channel, at Block 208, querying the system, at Block 210, and receiving detailed analyses and reports in real-time, at Block 212.

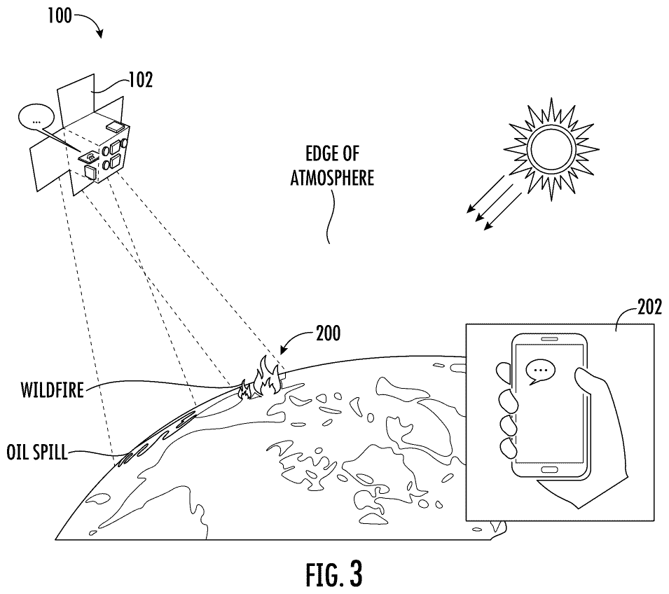

Referring now to FIG. 3, in operation of the system 100, the satellite 102 strategically captures hyperspectral data, which is processed in real-time by the onboard AI system. When the AI detects an event or anomaly that meets predefined criteria, such as a wildfire or oil spill 200, it automatically generates an alert and prioritizes the data for immediate analysis and transmission. Users receive these alerts 202 and can engage in an interactive session with the onboard AI, requesting further analysis or clarification, thus enabling rapid decision-making and action.

In addition to generating sensor insights onboard, the system 100 described herein supports real-time, interactive communication between a ground-based operator and the onboard artificial intelligence (AI) system 104. The AI processing and analysis unit 104 is configured not only to detect and transmit predefined insights, but also to engage in dynamic query-response exchanges with ground personnel. This capability enables operators to request additional analyses, clarifications, or follow-up insights directly from the satellite in response to an initial alert or data product.

Unlike conventional systems that rely on unidirectional “data push” architectures where the satellite transmits data or pre-set alerts with no interactive feedback, the present system 100 implements a two-way communication paradigm, allowing for natural-language queries or structured commands to be sent from a ground station. These operator queries are received via the satellite's communication module 106 and are processed by the onboard AI processing unit 104, which include the LLM or similar interpretive framework.

Upon receiving a query, the onboard AI processing unit 104 can access the locally stored hyperspectral data cubes, perform context-specific analysis, and generate a responsive insight or report. The response is then transmitted back to the operator using low-bandwidth messaging. This functionality transforms the satellite from a passive data collector into an interactive analyst, capable of tailoring output to operator needs and enabling more responsive and targeted decision-making.

For example, upon receiving a wildfire alert from the satellite, an operator might query: “What is the estimated area affected over the past 6 hours?” or “Are there any nearby water sources within 5 km?” The onboard AI can process these queries using the existing sensor data, perform appropriate geospatial or spectral analysis, and transmit a concise, actionable response. This real-time query handling significantly enhances mission agility and the effective use of satellite resources in time-sensitive or evolving scenarios.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A satellite sensing payload comprising:
a plurality of hyperspectral imaging sensors configured to capture sensor data across a plurality of wavelengths;
a communication device configured to communicate with a ground station; and
an artificial intelligence (AI) processing and analysis unit configured to
store the captured sensor data in data cubes,
process the data cubes to generate at least one sensor insight based thereon, and
communicate the at least one sensor insight with the ground station via the communication device.

2. The satellite sensing payload of claim 1, wherein the AI processing and analysis unit is configured to communicate the at least one sensor insight in real-time.

3. The satellite sensing payload of claim 1, wherein the AI processing and analysis unit is configured to engage in dialogue via the communication device and the ground station.

4. The satellite sensing payload of claim 1, wherein communication of the at least one insight requires less bandwidth than would otherwise be required by communication of the captured sensor data.

5. The satellite sensing payload of claim 1, wherein the AI processing and analysis unit is configured to operate a Large Language Model (LLM).

6. The satellite sensing payload of claim 1, wherein the AI processing and analysis unit is configured to identify at least one of a pattern, anomaly, and trend to generate the at least one sensor insight.

7. The satellite sensing payload of claim 1, wherein the AI processing and analysis unit is further configured to receive a user query from the ground station and dynamically generate a responsive sensor insight based on the stored data cubes.

8. The satellite sensing payload of claim 1, wherein the AI processing and analysis unit is further configured to assign a priority value to each sensor insight based on a relevance score or event threshold and to selectively transmit insights exceeding a predetermined priority level.

9. The satellite sensing payload of claim 1, wherein the sensor insight comprises a textual summary, a geolocation tag, or a structured data packet formatted for human or machine interpretation.

10. A satellite sensing payload comprising:
a plurality of hyperspectral imaging sensors configured to capture sensor data across a plurality of wavelengths;
a communication device configured to communicate with a ground station; and
an artificial intelligence (AI) processing and analysis unit configured to
store the captured sensor data in data cubes,
process the data cubes to generate at least one sensor insight based thereon,
communicate the at least one insight with the ground station via the communication device in real-time, and
engage in dialogue via the communication device and the ground station.

11. The satellite sensing payload of claim 10, wherein communication of the at least one sensor insight requires less bandwidth than would otherwise be required by communication of the captured sensor data.

12. The satellite sensing payload of claim 10, wherein the AI processing and analysis unit is configured to operate a Large Language Model (LLM).

13. The satellite sensing payload of claim 10, wherein the AI processing and analysis unit is configured to identify at least one of a pattern, anomaly, and trend to generate the at least one sensor insight.

14. A method of satellite sensing comprising:
operating a plurality of hyperspectral imaging sensors of a satellite sensing payload to capture sensor data across a plurality of wavelengths; and
operating an artificial intelligence (AI) processing and analysis unit of the satellite sensing payload unit to
store the captured sensor data in data cubes,
process the data cubes to generate at least one sensor insight based thereon, and
communicate the at least one sensor insight with a ground station via a communication device of the satellite sensing payload.

15. The method of claim 14, wherein operating AI processing and analysis unit comprises operating the AI processing and analysis unit to communicate the at least one sensor insight in real-time.

16. The method of claim 14, wherein operating AI processing and analysis unit comprises operating the AI processing and analysis unit to engage in dialogue via the communication device and the ground station.

17. The method of claim 14, wherein communication of the at least one sensor insight requires less bandwidth than would otherwise be required by communication of the captured sensor data.

18. The method of claim 14, wherein the AI processing and analysis unit operates a Large Language Model (LLM).

19. The method of claim 14, wherein operating AI processing and analysis unit comprises operating the AI processing and analysis unit to identify at least one of a pattern, anomaly, and trend to generate the at least one sensor insight.

20. The method of claim 14, further comprising receiving, at the AI processing and analysis unit, a user query from the ground station, and generating, by the AI processing and analysis unit in response to the query, a responsive sensor insight based on the stored data cubes.
